(19) United States
(12) Patent Application Publication
(10) Pub. No.: US 2006/0286320 A1
(43) Pub. Date: Dec. 21, 2006

(54) Targeted reinforcement

(76) Inventor: Terrell J. Green, Beaumont, TX (US)

Correspondence Address: THOMPSON HINE L.L.P., P.O. BOX 8801, DAYTON, OH, 45401-8801, US

(21) Appl. No.: 11/158,183

(22) Filed: Jun. 21, 2005

(51) Int. Cl. B32B 27/10; B32B 27/22

(52) U.S. Cl. 428/34.2; 428/532; 428/510; 428/537.5; 428/339

(57) ABSTRACT

A reinforced product including a repulpable substrate and an aqueous-soluble polymeric material applied to the repulpable substrate to reinforce the repulpable substrate.

The present application is directed to a reinforced paperboard product and, more particularly, a repulpable reinforced paperboard product.

### BACKGROUND

Paperboard products are typically used for packaging various items such as soft drink bottles and beer bottles. A typical twelve-pack of bottled beer may be packaged in a carrier carton of the type illustrated, in top plan view, in FIG. 1 and generally designated 10. The carrier carton 10 may be constructed from a paperboard blank having a thickness of, for example, about 24 points.

The carrier carton 10 may include a racetrack-type carry handle 12, which includes two openings 14, 16 and a gripping portion 18 positioned between the two openings 14, 16. The openings 14, 16 may be sized to receive a human hand, thereby allowing a user to grasp the gripping portion 18 for lifting and carrying the carton 10.

However, carrier cartons 10 formed from paperboard blanks have several disadvantages. In particular, such carrier cartons 10 often include areas of weakness where the paperboard is more likely to fail. One such common area of weakness may be the seams and folds lines in the paperboard blank that are used to form the carrier carton 10. Another common area of weakness may be the handle 12.

Various techniques have been developed to reinforce paperboard products (e.g., carrier carton 10), thereby alleviating the disadvantages discussed above. One such technique is disclosed in U.S. Pat. No. 4,617,223 to Hiscock et al., the entire contents of which are incorporated herein by reference. The Hiscock et al. patent discloses a paperboard carton reinforced with patterned areas of polyurethane reinforcement.

Despite the advances of prior art reinforcing techniques, another disadvantage of paperboard products is the large volume of paperboard waste that is generated by consumers each year. Quite often, the paperboard becomes trash and occupies valuable space in waste disposal sites such as landfills. Thus, it may be desirable to recycle and/or repulp the used paperboard products, thereby avoiding the environmental implications and increasing profitability. However, prior art reinforcing techniques that utilize polymeric materials make it difficult, if not impossible, to repulp reinforced paperboard products.

Accordingly, there is a need for a technique for reinforcing paperboard products and the like that yields a repulpable product.

### SUMMARY OF THE INVENTION

In one aspect, the present invention provides a reinforced product including a repulpable substrate and an aqueous-soluble polymeric material applied to the repulpable substrate to reinforce the repulpable substrate.

In another aspect, the present invention provides a reinforced paperboard product including a paperboard substrate and a polyvinyl alcohol composition applied to the paperboard substrate to reinforce the paperboard substrate

In another aspect, the present invention provides a method for reinforcing a repulpable substrate including the steps of providing a polyvinyl alcohol composition and applying the polyvinyl alcohol composition to select areas of the repulpable substrate.

Other aspects of the present invention will become apparent from the following description, the accompanying drawings and the appended claims.

### BRIEF DESCRIPTION OF THE DRAWINGS

FIG. 1 is a top plan view of a prior art carrier carton;

FIG. 2 is a top plan view of a carrier carton according to a first aspect of the present invention;

FIG. 3 is a top plan view of a carrier carton according to a second aspect of the present invention; and

FIG. 4 is a top plan view of a carrier carton according to a third aspect of the present invention.

### DETAILED DESCRIPTION

A first aspect of the present invention provides a substrate reinforced with a repulpable reinforcing composition.

The repulpable substrate according to the present invention may be any substrate capable of being broken down and dispersed in an aqueous solution or capable of being repulped. For example, the repulpable substrate may be various grades of hardwood, softwood and the like and may include a furnish that may be up to 100% recycled fiber. In one aspect, the substrate is a paperboard material or product or other paper-like material. The substrate may have a thickness of about 1 to about 100 points and may include one or more layers of substrate. For example, the substrate may be a 24 point paperboard blank for forming various cartons.

The repulpable reinforcing composition of the present invention may be a polyvinyl alcohol based composition. In one aspect, the repulpable reinforcing composition may be in liquid form and may be applied to the substrate as a liquid (or aqueous solution) and allowed to dry, thereby leaving a dry film on a surface of the substrate. In a second aspect, the repulpable reinforcing composition may be a sheet (or film) of polyvinyl alcohol material. The sheet may be applied to the substrate by any known means such as glue, adhesives, lamination (i.e., heat) or the like. In one aspect, the glues and adhesives may be water-based and/or water-soluble. In another aspect, the glue or adhesive may be a water soluble vinyl acetate glue.

Thus, according to the present invention, the repulpable reinforcing composition may be applied to a substrate to form a film on the substrate, wherein the film acts as a reinforcing agent. The film may be applied by spraying, rollers or the like. In one aspect, the film has a thickness of about 1 mil to about 5 mils. In another aspect, the film has a thickness of about 0.01 mils to about 10 mils. The film may be solubilized when the substrate is repulped (due to the polyvinyl alcohol) in an aqueous solution such as a pulping solution or hot water.

According to one aspect of the present invention, the repulpable reinforcing composition may be a mixture or adduct of polyvinyl alcohol and a plasticizer. The plasticizer may be any plasticizer compatible with polyvinyl alcohol and may be present in the composition at a concentration of about 0 to about 50 percent by weight. In one aspect, the plasticizer may be present at a concentration of about 0 to about 20 percent by weight plasticizer and the polyvinyl alcohol may be present at a concentration of about 80 to about 100 percent by weight polyvinyl alcohol. In another aspect, the repulpable reinforcing composition may be ELVANOL (a registered trademark of E.I. DuPont de Nemours & Co., Inc.), such as ELVANOL 85/82 or the like.

At this point it should become apparent to those skilled in the art that the repulpable reinforcing composition of the present invention may be any appropriate polyvinyl alcohol composition. Alternatively, the repulpable reinforcing composition may be any aqueous-soluble polymer that may be solubilized or dissolved in a pulping solution, hot water or the like. Furthermore, it should be understood that various compounds may be added to the repulpable reinforcing composition within the scope of the present invention. For example, compounds may be added to prevent degradation of the polyvinyl alcohol film due to heat or light, to give a tack-free film, or to increase the strength of the film, for example.

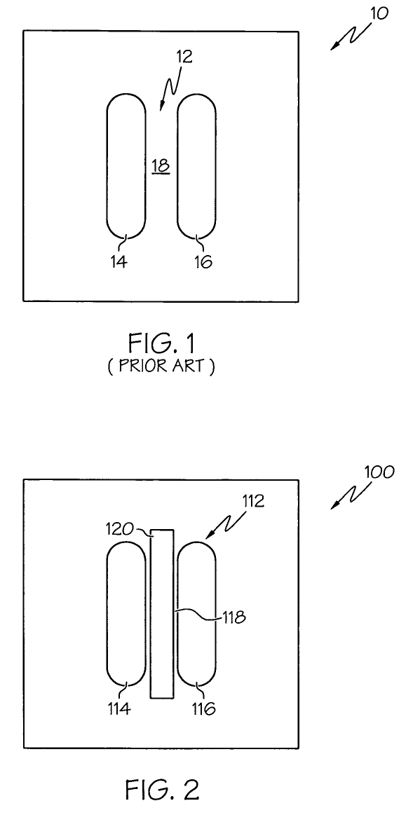

As illustrated in FIGS. 2-5, strips or films of the repulpable reinforcing composition may be applied to a surface of the substrate to reinforce the substrate (e.g., increase the tear strength of the substrate). In particular, the repulpable reinforcing composition may be applied to the substrate at areas of weakness.

As shown in FIG. 2, the substrate according to one embodiment of the present invention may be a carrier carton 100 (similar to carrier carton 10 of FIG. 1), which includes a racetrack-type carry handle 112. The racetrack-type carry handle 112 may include two openings 114, 116 and a gripping portion 118 positioned between the two openings 114, 116. The openings 114, 116 may be sized to receive a human hand, thereby allowing a user to grasp the gripping portion 118 for lifting and carrying the carton 100. The carry handle 112 may be reinforced with a strip 120 of the repulpable reinforcing material laminated (or otherwise applied) to the gripping portion 118 of the handle 112.

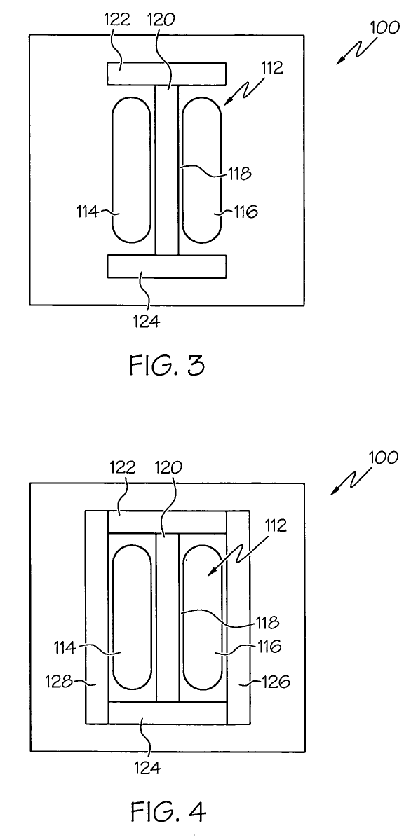

The repulpable reinforcing material may be applied to a substrate in various other configurations within the scope of the present invention. For example, FIG. 3 illustrates the carton 100 having three strips 120, 122, 124 of repulpable reinforcing material applied to the substrate in a generally H-shaped configuration and FIG. 4 illustrates the carton 100 having five strips 120, 122, 124, 126, 128 of repulpable reinforcing material applied to the substrate. In another aspect of the present invention, the repulpable reinforcing material may be applied to various portions of the substrate, such as the seams, the edges or the entire surface of the substrate.

It should be understood that FIGS. 2-4 are only illustrative and that various areas and patterns of reinforcement are within the scope of the present invention. Furthermore, it should be understood that the repulpable reinforcing material may be used to reinforce substrates other than cartons having racetrack-type carry handles.

### EXAMPLE 1

Three different batches of the repulpable reinforcing composition were prepared according to the present invention. The first batch included about 100 percent by weight polyvinyl alcohol (PV(OH)) (i.e., no plasticizer). The second batch included about 90 percent by weight PV(OH) and about 10 percent by weight plasticizer. The third batch included about 80 percent by weight PV(OH) and about 20 percent by weight plasticizer. Each batch of repulpable reinforcing composition was drawn into three different films, each film having a different thicknesses (i.e., 2 mils, 3 mils and 4 mils). Ten blanks of an 18 point paperboard were obtained for use as a substrate.

One substrate blank was set aside as a control. The remaining nine substrate blanks were laminated with the nine different films (using glue), as indicated in Table 1 below, and subjected to Elmendorf tear testing. The results are set forth in Table 1.

TABLE 1

| | | | | Tear |
|---|---|---|---|---|
| Sample | PV(OH) | Plasticizer Film | Thickness | Strength |
| Number | (%) | (%) | (mils) | (g/m²) |
| Control | 0 | 0 | 0 | 440.3 |
| 1 | 100 | 0 | 2 | 697.0 |
| 2 | 90 | 10 | 2 | 769.3 |
| 3 | 80 | 20 | 2 | 714.2 |
| 4 | 100 | 0 | 3 | 878.7 |
| 5 | 90 | 10 | 3 | 973.4 |
| 6 | 80 | 20 | 3 | 1133.4 |
| 7 | 100 | 0 | 4 | 943.4 |
| 8 | 90 | 10 | 4 | 1210.2 |
| 9 | 80 | 20 | 4 | 1550.4 |

The test results confirm that the repulpable reinforcing composition of the present invention has a significant reinforcing effect and is capable of increasing the tear strength of paperboard substrates by at least 300 percent.

### EXAMPLE 2

Paperboard substrates were prepared for repulpability testing as follows: a first group of samples were not coated (i.e., the control), a second group of samples were coated with a 2 mil ELVANOL film (i.e., a polyvinyl alcohol/plasticizer composition) and a third group of samples were coated with a 4 mil ELVANOL film. A repulper was adjusted to neutral pH and 120° f. The samples were introduced into the repulper by group (i.e., control, 2 mil and 4 mil) and repulpability was monitored at 15 and 30 minutes. The results are set forth in Table 2.

TABLE 2

| | Control | 2 mil | 4 mil |
|---|---|---|---|
| 15 minute accepts | 31.1% | 25.2% | 25.6% |
| 15 minute rejects | 68.9% | 74.8% | 74.3% |
| 30 minute accepts | 38.1% | 34.7% | 33.3% |
| 30 minute rejects | 61.9% | 65.3% | 66.7% |

Accordingly, substrates reinforced according to the foregoing detailed description are repulpable. Furthermore, as shown in Table 2, substrates reinforced according to the foregoing detailed description are repulpable almost as well as uncoated substrates.

At this point, those skilled in the art should appreciate that a composition of polyvinyl alcohol and a plasticizer, wherein the plasticizer is present in an amount of about 0 to about 50 percent, may be applied to a substrate as a film having a thickness of about 0.1 to about 10 mils to substantially improve the tear strength of the substrate, while allowing the substrate to be easily repulped due to the water soluble nature of polyvinyl alcohol films. Furthermore, it should be apparent that by varying the amount of plasticizer and/or the film thickness, those skilled in the art may be able to obtain a reinforced and repulpable substrate having improved tear strength.

Although the present invention is shown and described with respect to certain aspects, it is obvious that various modifications will become apparent to those skilled in the art upon reading and understanding the specification and the appended claims. The present invention includes all such improvements and modifications and is limited only by the scope of the claims.

What is claimed is:

1. A reinforced product comprising:
a repulpable substrate; and
an aqueous-soluble polymeric material applied to said repulpable substrate to reinforce said repulpable substrate.

2. The reinforced product of claim 1 wherein said aqueous-soluble polymeric material is a polyvinyl alcohol composition.

3. The reinforced product of claim 1 wherein said aqueous-soluble polymeric material is ELVANOL.

4. The reinforced product of claim 1 wherein said aqueous-soluble polymeric material includes polyvinyl alcohol and a plasticizer.

5. The reinforced product of claim 4 wherein said aqueous-soluble polymeric material includes about 0 to about 50 percent plasticizer.

6. The reinforced product of claim 1 wherein said repulpable substrate is paperboard.

7. The reinforced product of claim 1 wherein said repulpable substrate is a paperboard carrier carton having a racetrack-type carry handle and said aqueous-soluble polymeric material is applied to said carry handle.

8. The reinforced product of claim 1 wherein said aqueous-soluble polymeric material is a film and said film is applied to said repulpable substrate by at least one of a glue, an adhesive and lamination.

9. The reinforced product of claim 8 wherein said film is about 0.01 to about 10 mils thick.

10. The reinforced product of claim 1 wherein said aqueous-soluble polymeric material is applied to said repulpable substrate as a liquid and said liquid is allowed to dry into a film.

11. The reinforced product of claim 10 wherein said film is about 1 to about 5 mils thick.

12. A reinforced paperboard product comprising:
a paperboard substrate; and
a polyvinyl alcohol composition applied to said paperboard substrate to reinforce said paperboard substrate.

13. The reinforced paperboard product of claim 12 wherein said polyvinyl alcohol composition is ELVANOL.

14. The reinforced paperboard product of claim 12 wherein said polyvinyl alcohol composition includes a plasticizer.

15. The reinforced paperboard product of claim 14 wherein said plasticizer is present in an amount of about 0 to about 20 percent plasticizer.

16. The reinforced paperboard product of claim 12 wherein said paperboard substrate is a paperboard carrier carton having a racetrack-type carry handle and said polyvinyl alcohol composition is applied to said carry handle.

17. The reinforced paperboard product of claim 12 wherein said polyvinyl alcohol composition is applied to said paperboard substrate as a film.

18. The reinforced paperboard product of claim 17 wherein said film is about 1 to about 5 mils thick.

19. A method for reinforcing a repulpable substrate comprising the steps of:
providing a polyvinyl alcohol composition; and
applying said polyvinyl alcohol composition to select areas of said repulpable substrate.

20. The method of claim 19 wherein said polyvinyl alcohol composition is a film and said film is applied to said repulpable substrate by at least one of a glue, an adhesive and lamination.
